(19) United States
(12) Patent Application Publication
(10) Pub. No.: US 2025/0162930 A1
(43) Pub. Date: May 22, 2025

(54) GLAZING HAVING HYDROPHOBIC PROPERTIES BY THE GASEOUS RELEASE OF HYDROPHOBIC COMPOUNDS CONTAINED IN AN EMITTER

(71) Applicant: SAINT-GOBAIN GLASS FRANCE, COURBEVOIE (FR)

(72) Inventors: Thomas TONDU, COURBEVOIE (FR); Maxime THEBAULT, COURBEVOIE (FR); Lorenzo MANCINI, AUBERVILLIERS (FR)

(21) Appl. No.: 18/841,939

(22) PCT Filed: Feb. 27, 2023
(86) PCT No.: PCT/FR2023/050269

§ 371 Date: Aug. 27, 2024

(30) Foreign Application Priority Data
Feb. 28, 2022 (FR) FR2201737

(51) Int. Cl. C03C 17/28; C03C 17/22; C03C 17/23; C03C 17/42

(52) U.S. Cl. CPC C03C 17/28; C03C 17/225; C03C 17/23; C03C 17/42; C03C 2217/76; C03C 2218/15; C03C 2218/17

(57) ABSTRACT

A glazing includes a transparent substrate, and at the periphery of the substrate, at least one emitter of hydrophobic compounds by a gaseous process; the at least one emitter being arranged to enable the release of the hydrophobic compounds, and a fraction of the released hydrophobic compounds being able to be deposited on the surface of the transparent substrate.

The present invention relates to glazing comprising a transparent substrate, in particular a glass article, whose outer surface has been rendered hydrophobic by the gaseous release of hydrophobic compounds contained in an emitter placed at the periphery of said substrate. The invention relates in particular to rain-proof glazing for buildings, land vehicles, aircrafts or watercrafts, or urban furniture.

Hydrophobic properties are sought for windows and windscreens in the transport sector, particularly for motor vehicles and aircraft, as well as for glazing in the building industry. For transport applications, rain-proof properties are sought, as the water collected on the glazing and the areas upstream of the vehicle must run off easily in the form of droplets or rivulets onto the wall of glass in order to be evacuated, for example when driving under the effect of air and wind, in order to improve visibility and, consequently, safety, or to facilitate cleaning, easily remove frost, etc.

To this end, a contact angle is sought of a water droplet with the substrate that is greater than 60° or 70° and preferentially greater than 90°, so that the water droplet does not crush or spread until continuous films are formed. Indeed, glazing is said to be functional as long as this angle is greater than 60° for aviation and 70° for motor vehicles. To render a glass substrate hydrophobic, it is known to deposit hydrophobic fluorinated silane type grafted compounds on the outer surface thereof, as described in patent application U.S. Pat. No. 4,983,459. It is also known to coat the glass with a mineral layer serving as a primer for grafting said fluorinated silane molecules, said mineral layer being a dense silica layer such as that described in patent EP 0545201, or else a sol-gel silica layer such as that described in patent EP 799873, or even a layer of activated silicon such as that described in patent application WO 2005/084943. However, these hydrophobic coatings by grafting fluorinated silanes onto the outer surface of a glass substrate present risks to health and the environment due to the fluorinated compounds, which are, moreover, threatened by regulatory restrictions. Furthermore, these coatings tend to degrade over time as a result of the constant stress to which glazing is subjected, such as: hydrolysis, photodegradation, sensitivity to the impact of atmospheric dust, sensitivity to electrostatic discharges, etc. Thus, these hydrophobic fluorinated silane coatings have short lifespans, particularly in flight, for example of around 6 months when applied to the windscreen of a short-haul commercial aircraft. It could be possible to increase the thickness of the hydrophobic coating on the surface of the glazing in order to extend the lifespan thereof. Moreover, this strategy is used in the case of hydrophobic varnishes. However, these coatings are sensitive to scratches, which would also limit the lifespan thereof and the overall optical quality of the glazing would also be degraded. Additionally, these visible scratches are generally not repairable and may require the glazing to be replaced. Thus, thick functionalized coatings (>100 nm) should therefore not be considered as a solution to the aforementioned problems.

Furthermore, the loss of performance of coatings of hydrophobic fluorinated silane type grafted compounds is not very predictable since, as stated above, it is highly dependent on climatic and atmospheric conditions (exposure to dust, electrostatic surface discharge events, saline environment, etc.). In particular, the fluorinated silane-based solutions used in aviation glazing are very complex to regenerate. Indeed, the maintenance of such glazing requires an intervention protected from the rain with good access to the glazing, as well as good lighting to ensure good final optical quality, and heating systems to improve the fixation of fluorinated silanes. This also requires the availability of a hangar and often leads to a temporary interruption in the commercial exploitation of an airplane. Additionally, chemicals are used by specially trained operators and the short lifespan of the reagents prepared by these operators makes the processes sensitive to variations in deposition as well as to ambient temperatures. In other words, poor control of the deposition conditions can result in shortened lifespans for the hydrophobic functionalization of regenerated fluorinated silanes.

In conclusion, these fluorinated silane solutions degrade easily over time and generate maintenance costs, logistical complexities and reduced commercial aircraft availability for airlines.

The inventors have therefore sought to develop glazing comprising a transparent substrate, preferably glazing for an aircraft such as an airplane, having continuous hydrophobic properties and whose regeneration of the hydrophobic properties of said substrate is simple to implement. Advantageously, the inventors have sought to provide glazing with improved hydrophobic properties, particularly in terms of the durability and predictability thereof, while retaining other properties such as resistance to mechanical stress (resistance to friction, abrasion, wiping, etc.); resistance to climatic stress (resistance to UVA and UVB, neutral salt spray, acid rain, etc.); and retention of optical properties, particularly when the glazing is a glass article. Even more preferentially, the inventors have sought to use volatile hydrophobic compounds such that they can be applied continuously to the outer surface of the transparent substrate of glazing, without a maintenance intervention, in other words by continuous regeneration of the hydrophobic functions on the surface of said substrate.

The inventors have thus proposed that the hydrophobic compounds be transported by a gaseous process directly from an emitter located at the periphery of the transparent substrate of glazing to the outer surface of said substrate. Thus, the objective of the present invention is to provide glazing (1) comprising a transparent substrate (S), said glazing comprising, at the periphery of the substrate, at least one emitter (2) of hydrophobic compounds by a gaseous process; said at least one emitter being arranged to enable the release of said hydrophobic compounds, and a fraction of said released hydrophobic compounds being able to be deposited on the surface of said transparent substrate.

In fact, it was surprisingly found by the inventors that the gaseous release of hydrophobic compounds contained in at least one emitter located at the periphery of a transparent substrate of glazing made it possible to render the outer surface of said substrate hydrophobic. It has further been observed that this hydrophobic performance is maintained over time; as long as the balance of flows of hydrophobic compounds, between those arriving on the surface and from the emitter or from the environment on the one hand, and those leaving for the various reasons already mentioned (such as hydrolysis, evaporation, erosion, etc.) on the other hand, allows the persistence of a sufficient quantity of hydrophobic compounds, which can be approximated to a fraction of a molecular monolayer of hydrophobic compounds. The maintenance of a sufficient quantity of hydrophobic compounds on the surface of the transparent substrate is thus improved according to the invention, by generating a flow of hydrophobic compounds emitted by the emitter, and adding to the natural flows, and/or by a specifically strong affinity between the substrate surface and the hydrophobic compounds. Through this mechanism, the emitters associated with the air flows on the surface of the transparent substrate ensure continuous regeneration of the surface with hydrophobic compounds and therefore an improved hydrophobic performance of the substrate. If necessary, emitters may need to be regenerated by either replacing them, or recharging them with hydrophobic compounds.

The invention is shown using the following non-limiting figures:

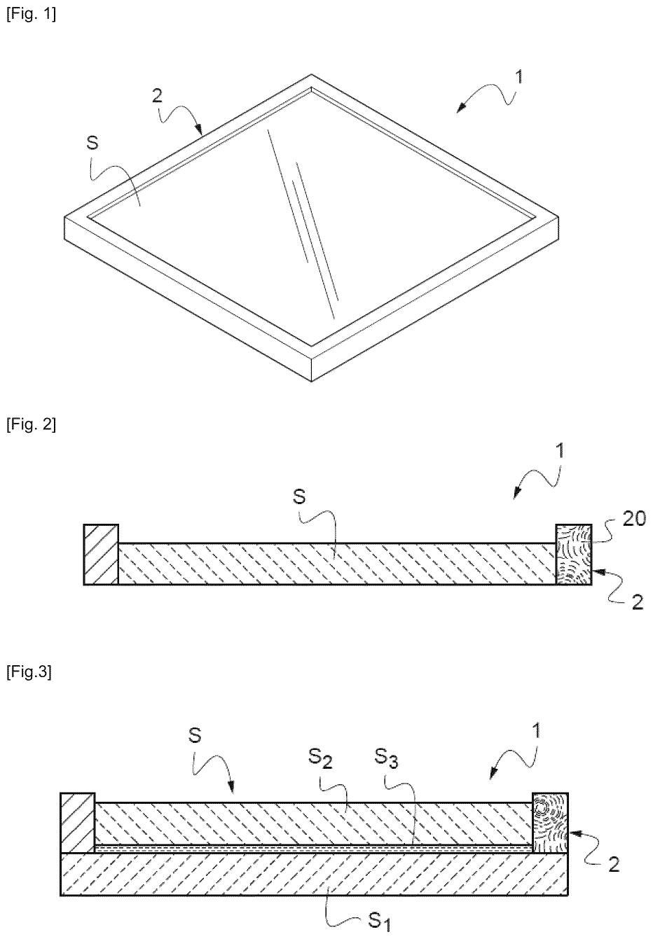

FIG. 1 (FIG. 1) schematically shows glazing (1) according to the invention;

FIGS. 2 (FIGS. 2) and 3 (FIG. 3) schematically show glazing (1) according to the invention, each comprising an example of substrate (S) and an emitter (2), the emitter (2) comprising in both figures at least one reservoir (20) in the form of a solid serving as an emitting surface;

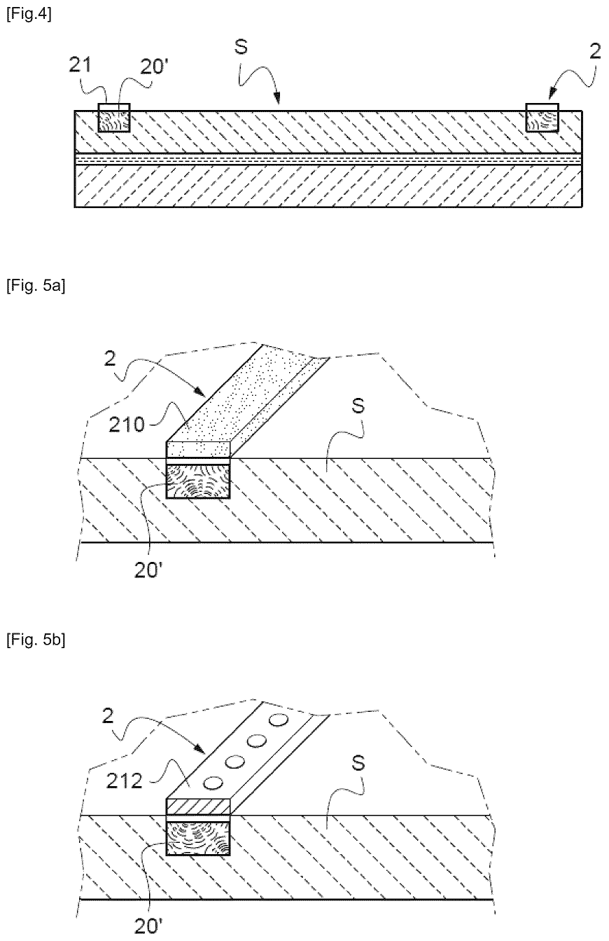

FIG. 4 (FIG. 4) schematically shows glazing (1) according to the invention wherein the emitter (2) comprises a reservoir (20′) and an emitting surface (21);

FIGS. 5a (FIGS. 5a) and 5b (FIG. 5b) schematically show glazing (1) comprising an emitter (2) which comprises a reservoir (20′) and an emitting surface (21) in the form of a membrane (210) or a plate provided with at least one opening (212) respectively;

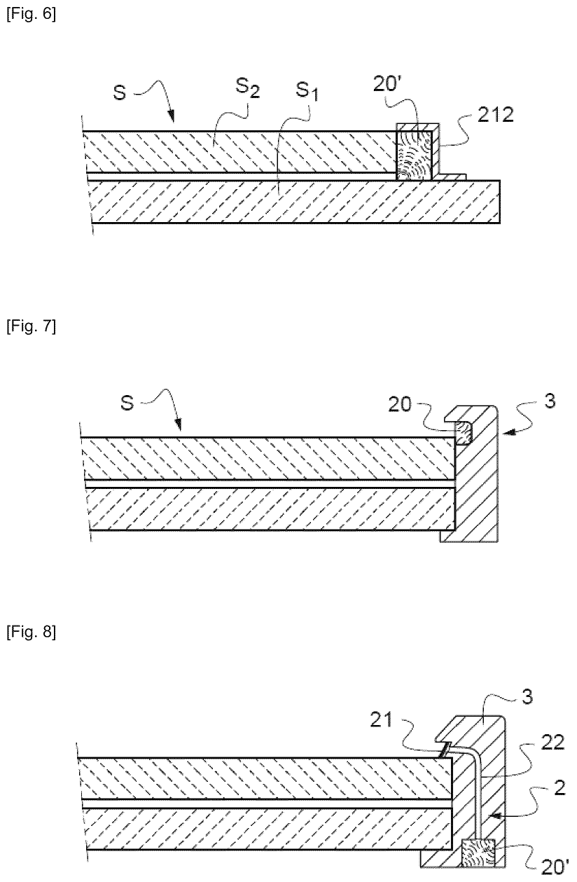

FIG. 6 schematically shows an example of glazing (1) according to the invention;

FIGS. 7 (FIGS. 7) and 8 (FIG. 8) schematically show glazing (1) according to the invention comprising a frame (3) wherein the transparent substrate (S) is mounted, and the emitter (2) is arranged at the level of the frame (3).

The transparent substrate (S) of glazing (1) according to the invention may comprise:
a ply of a material selected from the list comprising glass, glass-ceramic, polymer, as shown in FIG. 2, or
a laminated assembly of at least two plies (S1, S2), said plies being made of an identical or different material, said material being selected from the list comprising glass, glass-ceramic, polymer, as shown in FIG. 3.

According to the invention, “glass” is understood to mean mineral glass, in particular of the soda-lime-silica, borosilicate or aluminosilicate type.

The polymer can be selected from polycarbonate (PC), poly(methyl methacrylate) (PMMA), polyurethane (PU) and polyethylene terephthalate (PET).

In the case of a laminated assembly, the plies (S1, S2) are laminated or assembled by means of an interlayer (S3). This interlayer (S3) may comprise one or more adhesive layers of a polymer material. Said polymer material is preferably selected from thermoplastic polyurethane (TPU), polyvinyl butyral (PVB), poly(ethylene-vinyl acetate) (EVA), silicones and ionomer resins. Several different types of adhesive layer can be used on the same glazing between two successive or different pairs of plies and between the same pair of successive plies.

In a preferred embodiment, the glazing (1) is a laminated glazing whose substrate (S) comprises at least two glass plies (S1, S2) bonded or assembled by means of adhesive interlayers (S3) of the thermoplastic polyurethane, polyvinyl butyral or poly(ethylene vinyl acetate) type.

In another preferred embodiment, the glazing is a laminated glazing whose substrate comprises at least one ply of poly(methyl methacrylate) (PMMA), preferably at least two plies of PMMA bonded or assembled by means of adhesive interlayers as mentioned above.

In yet another preferred embodiment, the glazing is a laminated glazing whose substrate comprises at least one ply of polycarbonate (PC), preferably at least two plies of PC bonded or assembled by means of adhesive interlayers as mentioned above.

But other embodiments are possible such as glazing comprising at least one ply of polyethylene terephthalate (PET) and an adhesive layer of thermoplastic polyurethane (TPU) or polyvinyl butyral (PVB).

In the present invention, the glazing (1) comprises a transparent substrate (S) and at least one emitter (2) of hydrophobic compounds by a gaseous process which is positioned at the periphery of said transparent substrate, as is shown in FIGS. 1 and 2. In the present application, “emitter” is understood to mean a gas diffusion system. As a result, the emitter is designed to produce/emit gases and to supply them to the transparent substrate and in particular to supply them to the layer capable of adsorbing hydrophobic compounds. In the present application, “periphery” is understood to mean the zone corresponding to the connection or interface between the transparent substrate and the structure on which the substrate is placed, either on the substrate side, or on the structure side, and preferably upstream of air flows. It is also possible to move away from this zone (boundary), being limited by the visibility zone on the substrate side and extend even further upstream of the air flows on the structure side. However, a positioning in close proximity to the transparent substrate, particularly in the lower part of the glazing, is preferred. This positioning is particularly advantageous when the structure is that of a vehicle since it improves the efficiency of use of hydrophobic compounds by taking advantage of the air flow over the surface of the substrate (usually induced by the speed of the vehicle) in order to sweep over the surface with air loaded with hydrophobic compounds.

More specifically, in the case of glazing for an aircraft, the emitter is positioned in the glazing-airplane interface zone, either on the glazing side, or on the airplane side and upstream of the air flows sweeping over the glazing under flight conditions.

In a first configuration of the invention, the glazing comprises an emitter that extends around the entire periphery of the substrate.

In a second configuration of the invention, the glazing comprises at least two emitters arranged to extend around the entire periphery of the substrate.

In a third configuration of the invention, the glazing comprises one or at least two emitters at the periphery of said substrate but which do not extend around the entire periphery of the substrate.

The emitter according to the invention can have a linear geometry, for example in the form of a strip or slot or consist of several point emission sites for example in the form of holes. Additionally, the emitter can be integrated into the transparent substrate or integrated into the structure carrying the transparent substrate.

In a first embodiment, said emitter (2) according to the invention comprises at least one reservoir (20) in the form of a solid serving as an emitting surface, as shown in FIGS. 2 and 3.

Said reservoir (20) may then be flush and/or out of level with the surface of the transparent substrate of the glazing, and may comprise:
according to a first alternative, at least one pure hydrophobic compound or several hydrophobic compounds in a mixture, preferentially in solid form. According to this alternative, hydrophobic compounds are emitted by sublimation at the outer surface of the substrate, that is at the surface of the substrate exposed to the air, so that emission can thus be amplified by air convection; or
according to a second alternative, at least one hydrophobic compound solubilized and/or dispersed in a polymer matrix. The polymer matrix may comprise a polymer selected from polysulfides, epoxies, polyurethanes, silicones and rubbers. According to this alternative, the hydrophobic compound(s) solubilized and/or dispersed in said polymer matrix are in the form of solid grains or droplets that diffuse into said matrix, after which the hydrophobic compounds are desorbed and emitted in the gaseous phase onto the outer surface of the substrate. The polymer matrix helps to protect hydrophobic compounds which, without being encapsulated by said matrix, could at least under certain conditions of use sink when in a liquid state at high temperatures of use. The polymer matrix also protects hydrophobic compounds from dissolving in certain fluids, by erosion, rain or dust, or
according to a third alternative, at least one hydrophobic compound embedded in a porous matrix, in other words the hydrophobic compound(s) fill the pores of the porous matrix. The porous matrix can be metal, ceramic or fritted glass. Optionally, the porous matrix can consist essentially of a polymer and be for example in the form of a sponge or seal. Said porous matrix can be an open-pore matrix. Advantageously, the pore size of said matrix is between 1 μm and 0.1 mm to prevent rainwater penetrating into the reservoir. This open-pore porous matrix physically separates the reservoir from the outside air and allows hydrophobic compounds to diffuse through said open pores. This is followed by desorption then emission of hydrophobic compounds in a gaseous phase towards the outer surface of the substrate. The hydrophobic compounds filling the open pores of the matrix are either in liquid or solid form.

In a second embodiment, said emitter (2) according to the invention comprises a reservoir (20′) and an emitting surface (21), said reservoir (20′) being a volume communicating with said emitting surface (21), as shown in FIG. 4. In other words, in this second embodiment, the reservoir (20′) and the emitting surface (21) of the emitter (2) are dissociated. The volume of said reservoir may then comprise at least one hydrophobic compound found:
in solid form, or
in liquid form, or
solubilized and/or dispersed in a polymer matrix, or
embedded in a porous matrix.

In the particular case of a reservoir (20′) comprising at least one hydrophobic compound in liquid form, said reservoir may further comprise compounds without hydrophobic properties such as solvents or solid fillers. If required, elements such as fibers, powders or porous particles may be added to the reservoir to prevent liquid compounds from flowing through capillary mechanisms. The reservoir (20′) is thus designed to enable hydrophobic compounds to be transported in liquid form by direct contact, towards the emitting surface (21) which is flush with the outer surface of the substrate.

In particular cases where the reservoir (20′) comprises at least one hydrophobic compound in solid form, solubilized and/or dispersed in a polymer matrix, or embedded in a porous matrix, gaseous phase emissions of hydrophobic compounds occur towards the outer surface of the substrate by the emitting surface (21) as mentioned in the first embodiment.

The emitting surface (21) according to the invention may comprise:
at least one membrane (210), and/or
at least one plate with at least one opening (212).

According to a first alternative, the emitting surface (21) comprises at least one membrane (210), as shown in FIG. 5a. The membrane according to the invention may essentially consist of at least one polymer selected from polysulfides, polyurethanes, polyvinyl chlorides, and rubbers. Advantageously, the membrane is solid, thus making it a permeation membrane. The use of a membrane as an emitting surface enables hydrophobic compounds to be emitted by absorption on the reservoir side, followed by diffusion into the membrane then desorption and emission of said hydrophobic compounds in the gaseous phase on the face of the substrate exposed to the outside air (referred to as the outer face or external face of the substrate), with the advantage of better controlling or regulating the gaseous phase release of hydrophobic compounds towards the outer surface of the substrate.

According to a second alternative, the emitting surface (21) comprises at least one plate with at least one opening (212), as shown in FIG. 5b or FIG. 6. This plate can be a metal plate pierced by one or more slots or by a multitude of holes. These slots or these openings may all be identical or there may be openings or slots of different sizes and shapes.

According to a third alternative, the emitting surface (21) comprises at least one membrane (210) according to the first alternative and at least one plate (212) according to the second alternative.

Additionally, the emitter (2) may comprise a protective layer for the emitting surface (21), said protective layer being made of a porous material. The porous material is a material selected from ceramics, metal foams, fritted glass and polymeric foams.

In the particular case where the emitting surface (21) comprises at least one membrane (210) or a membrane (210) and a plate with at least one opening (212), said porous material is placed over the membrane, which itself can cover the openings in the plate if necessary. The purpose of this protective layer is to protect the membrane from the abrasive external environment, without hindering the gaseous transport of hydrophobic compounds.

In another particular case, when the emitting surface (21) comprises at least one plate provided with at least one opening (212), said porous material can cover said openings in the plate, acting as a “plug” to be filled with hydrophobic compounds. Filling can be achieved with liquid hydrophobic compounds by pouring them directly into the porous material (which can have the function of a wick). The plug(s) can then be accessed without having to remove the glazing.

In a preferred embodiment of the invention, when the reservoir (20′) comprises at least one hydrophobic compound in liquid form, said emitter (2) may further comprise at least one channel (22) connecting the emitting surface to the reservoir, as shown in FIG. 8. This allows the emitter to include a larger reservoir in order to be able to store a greater quantity of liquid hydrophobic compounds.

According to this embodiment, the emitter can also comprise a means of diffusion for supplying the entire emitting surface. This diffusion means can for example take the form of a cavity to which the entire emitting surface and channel are connected.

According to the second embodiment, the emitting surface (21) can extend particularly around the entire periphery of the transparent substrate, and more preferentially over all or part of the length of the bottom support of the glazing (1) with a width of up to 3 cm. This emitting surface can further be partially up to one millionth of its surface in the case of emission through a few thin holes having a diameter of between 0.05 mm and 2 mm.

According to the above-mentioned first and second particular embodiments, the reservoir (20) or (20′) may be in the form of a profile or a bulb or a parallelepiped or any other shape. The reservoir may essentially consist of a material selected from elastomers such as rubber, thermoplastic polymers such as polyvinyl chloride, or metals such as steel or aluminum.

More particularly, the emitter according to the invention also performs the function of a peripheral seal for glazing commonly referred to as a “bead”. The bead is indeed known to provide the glazing with aerodynamic continuity between the glazing and the mounting structure (such as the structure of an airplane), as well as good inertia to the treatment fluids (such as aeronautical fluids, cleaning products, degreasing agents, glycol for deicing on the ground and the like); this bead can be made of polysulfide or equivalent.

According to the present invention, the glazing (1) may further comprise at least one heating means. The heating means are preferably located in or around the emitter (2) so as to enable heating by thermal conduction: of the reservoir (20) or (20′), of the emitting surface (21) and, where applicable, of any elements enabling hydrophobic compounds to be transported from the reservoir to the emitting surface, such as channels (22) or tubes. Heating can be achieved using resistive wires, or resistive layers. The heating means can in particular be placed directly opposite the emitter. Alternatively, the heating means can be positioned in the transparent substrate (S) of the glazing (1). In the case of a laminated assembly, the heating means is placed inside the laminate, preferably in contact with the glass ply facing outwards. Said heating means can take the form of a transparent conductive layer, typically ITO-based or based on copper, nickel, iron-nickel alloys, or tungsten wires having a diameter of between 20 μm and 40 μm.

In the case of glazing for aircraft, the heating means are very useful. Indeed, convection and low pressure in flight conditions significantly accelerate the evaporation of hydrophobic compounds compared to ground conditions. On the other hand, the low temperatures encountered in flight significantly lower the partial pressures of hydrophobic compounds and therefore the molecular fluxes by a gaseous process. For this reason, the heating means optimize the preferential emission of hydrophobic compounds during flight phases which tend to carry the compounds towards the glazing, compared with emissions of hydrophobic compounds when the aircraft is on the ground.

In addition, the heating means can prevent the emitter from being blocked by frost.

According to the present invention, the glazing (1) may further comprise a frame (3) wherein the transparent substrate (S) is mounted. The frame (3) may be a metal profile or a polymer seal.

In the case of glazing for a vehicle, the frame is either an integral part of the vehicle or, as mentioned above, the frame is an element wherein the substrate is mounted and thus the assembly formed by the frame and the transparent substrate is then mounted in the vehicle.

In a preferred embodiment, the frame (3) is used to arrange the emitter (2). Indeed, the frame (3) can be arranged to carry the emitter (2), as shown in FIGS. 7 and 8 or be arranged so that the emitter is placed at the interface between the substrate and the frame.

As previously mentioned, the glazing (1), according to the invention, comprises a transparent substrate (S) and at least one emitter (2) of hydrophobic compounds by a gaseous process positioned at the periphery of the substrate; said at least one emitter being arranged to enable the release of said hydrophobic compounds, and a fraction of said released hydrophobic compounds being able to be deposited on the surface of said transparent substrate. In the present application, “by a gaseous process” is understood to mean that the hydrophobic compounds are transported between the emitter and the glazing in gaseous molecular form, subject to the phenomena of being carried by air flows and diffusion in a gaseous medium. As described above, the emitter can comprise pure hydrophobic compounds or diluted hydrophobic compounds in cases where these hydrophobic compounds are solubilized and/or dispersed in a polymer matrix or embedded in a porous matrix. Then, said hydrophobic compounds are: either exposed directly to air (when the emitter comprises a reservoir in the form of a solid serving as an emitting surface), or transported to an emitting surface such as a membrane or plate provided with openings (when the emitter comprises a reservoir and an emitting surface). Geometrically, the emission surface of hydrophobic compounds may therefore take on a multitude of forms. In the case of continuous emission or a multitude of emitting zones along the supports of a glazing, the emitting surface can be likened to an equivalent strip characterized by an equivalent slot width generating the same flow of contaminants. As a result, the emitting surface generates a flow of hydrophobic compounds less than or equal to the flow that would be emitted by the same surface consisting essentially of pure compounds. For example, an emitting surface comprising a 20 mm opening associated with a product diluted at 10% is equivalent to an emitting surface with a 2 mm opening for a pure compound. Those skilled in the art therefore know that the flows of hydrophobic compounds are weighted in relation to the emission surface, the dilution ratio, etc.

Additionally, the emitting surface may be a strip placed around the periphery of a transparent substrate of glazing or else one or more fractions (or piece(s)) placed around the periphery of the substrate, which also varies the vapor pressure of the hydrophobic compounds of the emitter. Those skilled in the art will take this variable into account and adapt each case in order to obtain the correct partial vapor pressure for releasing hydrophobic compounds.

Thus, the hydrophobic compounds of the emitter, according to the invention, preferably have a vapor pressure of between 10⁻⁸ Pa and 1 Pa, more preferentially between 10⁻⁸ Pa and 10⁻⁶ Pa for emitters with a large emitting surface of between 10 mm and 30 mm, and advantageously between 10⁻² Pa and 1 Pa for emitters with a small emitting surface of between 10 um and 3 mm. These partial pressures are defined at a temperature of between 20° C. and 30° C., more preferentially at a temperature equal to 25° C. This low vapor pressure, adapted to the emitting surface, enables hydrophobic compounds to be evaporated in sufficiently high quantities to enable functionalization of the transparent substrate while being limited to minimize consumption of hydrophobic compounds.

Once the hydrophobic compounds have been emitted by the emitter by a gaseous process, the hydrophobic compounds become part of the air flow that runs parallel to the transparent substrate of the glazing. In this air flow, hydrophobic compounds can diffuse and in particular in normal directions to the glazing surface, so that some of the compounds move away from the glazing and are lost, while some are redirected towards the outer surface of the transparent substrate on which they can adsorb. Thus, some or a fraction of the hydrophobic compounds released by the emitter condense on the surface of the glazing giving it hydrophobic characteristics.

The hydrophobic compounds of the emitter, according to the invention, are preferably selected from:
(a) a carboxylic acid of formula (I): R—COOH
wherein R represents a linear, branched or cyclic, saturated or unsaturated C₄-C₂₂ alkyl group, preferably R is an alkyl group of formula (A): CₙH₂ₙ₊₁, wherein n is between 6 and 20, or
(b) a phosphate of formula (II): R—O—PO(OH)₂
wherein R represents a linear, branched or cyclic, saturated or unsaturated C₄-C₂₂ alkyl group, preferably R is an alkyl group of formula (A): CₙH₂ₙ₊₁, wherein n is between 6 and 20, or
(c) a phosphonic acid of formula (III): R—PO(OR′)(OR″)
wherein R, R′ et R″ represent a hydrogen atom, a C₄-C₂₂ alkyl group or an aryl group, preferably R, R′ et R″ are alkyl groups of formula (A): CₙH₂ₙ₊₁, wherein n is between 6 and 20, or
(d) a silicone,
(e) a kerosene, or
(f) a mixture thereof.

More preferentially, the hydrophobic compounds are selected from carboxylic acids of formula (IA): CₙH₂ₙ₊₁—COOH, wherein n is between 7 and 19. In the particular case of a large emitting surface, the preferred carboxylic acid is stearic acid (n is equal to 17) since this hydrophobic compound has the advantage of being inexpensive, without risk to health or the environment and is sufficiently volatile. And in the particular case of a small emitting surface, for example obtained by openings in a plate pierced with 0.1 mm diameter openings spaced a few millimeters apart and aligned parallel to the edge of the glass, the preferred carboxylic acid is decanoic acid (n is equal to 9) since this hydrophobic compound has the advantage of being liquid which allows easy refilling of the reservoir while remaining a safe and inexpensive compound.

Indeed, the inventors have selected hydrophobic compounds that are:
sufficiently volatile to be able to evaporate, vaporize or sublimate easily,
chemically stable to avoid polymerization reactions, and
resistant to climatic or atmospheric conditions, such as oxidation, UV, neutral salt spray, etc.

The transparent substrate (S) of the glazing (1) may further comprise on its outer face at least one layer capable of adsorbing hydrophobic compounds. For the purposes of the present invention, the outer (or “external”) face corresponds to the face of the transparent substrate facing the outside of a building or a vehicle.

The layer capable of adsorbing hydrophobic compounds may comprise:
at least one oxide or nitride of a lanthanide, or an alloy of at least two lanthanides, the lanthanide being selected from the list comprising lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), or
at least one oxide or nitride of a metal or of an alloy of at least two metals, the metal being selected from the list comprising scandium (Sc), yttrium (Y), titanium (Ti), zirconium (Zr), hafnium (Hf), or
at least one oxide or nitride of an alloy comprising a lanthanide and a metal selected from the above-mentioned lists.

Advantageously, the layer capable of adsorbing hydrophobic compounds consists essentially of a material selected from cerium oxide (CeOₓ), gadolimium oxide (Gd), yttrium oxide (YOₓ), titanium oxide (TiOₓ), zirconium oxide (ZrOₓ) or hafnium oxide (HfOₓ).

And, examples of alloys include the following mixed oxides, such as TiYOₓ, HfYOₓ, HfZrOₓ, ZrYOₓ or GdYOₓ.

Additionally, it should be noted that the layers capable of adsorbing hydrophobic compounds according to the invention are deposited on the outer face of the transparent substrate by a physical vapor deposition (PVD) or chemical vapor deposition (CVD) process, such as sputtering, or by evaporation or by atomic layer deposition (ALD) or alternatively by a liquid sol-gel type process.

The layers capable of adsorbing compounds may have a thickness of between 5 and 1000 nm, preferably between 6 and 200 nm, and more preferentially between 7 and 30 nm.

The inventors found that at least one layer capable of adsorbing hydrophobic compounds placed on the outer face of the substrate favored adsorption of hydrophobic compounds after diffusion and transport thereof by virtue of air flows.

The transparent substrate may further comprise on its outer face at least one additional layer which does not have the function of adsorbing volatile hydrophobic compounds. For example, said additional layer may have electrical dissipative properties. Said additional layer may be placed over or under said at least one layer capable of adsorbing hydrophobic compounds. Said additional layer preferably consists essentially of a material selected from tin oxide or indium-tin oxide.

The glazing (1) according to the invention is advantageously used as rain-proof glazing, and even more advantageously as glazing in buildings, land vehicles, aircrafts or watercrafts, or urban furniture, preferably as aircraft cockpit glazing.

The present invention also relates to a method for hydrophobizing glazing (1) as described above comprising the following steps:
gaseous release of hydrophobic compounds from the emitter (2) at a pressure ranging from 2.10⁴ Pa to 10⁵ Pa,
depositing a fraction of said released hydrophobic compounds on the transparent substrate using a flow or a stream of air running parallel to said transparent substrate and at a speed of at least 70 meters per second.

During the method, a fraction of the hydrophobic compounds released by the emitter condense on the surface of the glazing giving it hydrophobic characteristics. By virtue of the emitter, it is thus understood that the glazing according to the invention can be hydrophobized and this hydrophobization can be renewed over time. In fact, the emitter associated with the air flows on the surface of the transparent substrate ensure continuous regeneration of the surface with hydrophobic compounds and therefore an improved hydrophobic performance of the substrate.

1. A glazing comprising a transparent substrate, comprising, at a periphery of the transparent substrate, at least one emitter of hydrophobic compounds by a gaseous process;
said at least one emitter being arranged to enable the release of said hydrophobic compounds, and
a fraction of said released hydrophobic compounds being able to be deposited on the a surface of said transparent substrate.

2. The glazing according to claim 1, wherein said transparent substrate comprises:
a ply of a material selected from glass, glass-ceramic, or polymer, or
a laminated assembly of at least two plies, said plies being made of an identical or different material, said material being selected from glass, glass-ceramic, or polymer.

3. The glazing according to claim 1, wherein said transparent substrate further comprises on its outer face at least one layer capable of adsorbing hydrophobic compounds.

4. The glazing according to claim 3, wherein the layer capable of adsorbing hydrophobic compounds comprises:
at least one oxide or nitride of a lanthanide, or an alloy of at least two lanthanides, the lanthanide being selected from the first group consisting of lanthanum, cerium, praseodymium, neodymium, promethium, samarium, europium, gadolinium, terbium, dysprosium, holmium, erbium, thulium, ytterbium, and lutetium, or
at least one oxide or nitride of a metal or of an alloy of at least two metals, the metal being selected from the second group consisting of scandium, yttrium, titanium, zirconium, and hafnium, or
at least one oxide or nitride of an alloy comprising a lanthanide and a metal selected from the first and second groups.

5. The glazing according to claim 3, wherein the layer capable of adsorbing hydrophobic compounds has a thickness of between 5 and 1000 nm.

6. The glazing according to claim 1, wherein said at least one emitter comprises at least one reservoir in a form of a solid serving as an emitting surface, said reservoir comprising:
at least one pure hydrophobic compound or several hydrophobic compounds in a mixture, or
at least one hydrophobic compound solubilized and/or dispersed in a polymer matrix, or
at least one hydrophobic compound embedded in a porous matrix.

7. The glazing according to claim 1, wherein said at least one emitter comprises a reservoir and an emitting surface, said at least one reservoir being a volume communicating with said emitting surface.

8. The glazing according to claim 7, wherein the volume of said reservoir comprises at least one hydrophobic compound found:
in solid form, or
in liquid form, or
solubilized and/or dispersed in a polymer matrix, or
embedded in a porous matrix.

9. The glazing according to claim 7, wherein the emitting surface comprises:
at least one membrane, and/or
at least one plate with at least one opening.

10. The glazing according to claim 7, wherein the at least one emitter comprises a protective layer for the emitting surface, said protective layer being made of a porous material.

11. The glazing according to claim 8, wherein when the reservoir comprises at least one hydrophobic compound in liquid form, the at least one emitter further comprises at least one channel connecting the emitting surface to the reservoir.

12. The glazing according to claim 11, wherein the at least one emitter further comprises a diffusion means.

13. The glazing according to claim 1, it further comprising at least one means of heating the emitter.

14. The glazing according to claim 1, further comprising a frame wherein the transparent substrate is mounted.

15. The glazing according to claim 14, wherein said frame is arranged to also carry the at least one emitter.

16. The glazing according to claim 1, wherein the hydrophobic compounds of the at least one emitter have a vapor pressure of between 10⁻⁸ Pa and 1 Pa, at a temperature of between 20° C. and 30° C.

17. The glazing according to claim 1, wherein the hydrophobic compounds of the at least one emitter are selected from:
(a) a carboxylic acid of formula (I): R—COOH
wherein R represents a linear, branched or cyclic, saturated or unsaturated C₄-C₂₂ alkyl group, or
(b) a phosphate of formula (II): R—O—PO(OH)₂
wherein R represents a linear, branched or cyclic, saturated or unsaturated C₄-C₂₂ alkyl group, or
(c) a phosphonic acid of formula (III): R—PO(OR′)(OR″)
wherein R, R′ et R″ represent a hydrogen atom, a C₄-C₂₂ alkyl group or an aryl group, or
(d) a silicone,
(e) a kerosene, or
(f) a mixture thereof.

18. A method comprising providing a glazing according to claim 1 as rain-proof glazing.

19. The method according to claim 18, wherein the glazing is a glazing in a building, a land vehicle, an aircraft or a watercraft, or an urban furniture.

20. A method for hydrophobizing glazing according to claim 1, comprising:
gaseous release of hydrophobic compounds from the at least one emitter at a pressure ranging from 2.10⁴ Pa to 10⁵ Pa, and
depositing a fraction of said released hydrophobic compounds on the transparent substrate using a flow or a stream of air running parallel to said transparent substrate and at a speed of at least 70 meters per second.
